(19) United States
(12) Patent Application Publication
(10) Pub. No.: US 2022/0279744 A1
(43) Pub. Date: Sep. 8, 2022

(54) CLEANING APPARATUS FOR PLANT SUPPORT TOWER

(71) Applicant: MJNN LLC, South San Francisco, CA (US)

(72) Inventors: Mark Cuson, Los Altos, CA (US); Jordan Giglio, Charlotte, NC (US); Charles Dylan Karr, San Francisco, CA (US); Matthew James Matera, San Francisco, CA (US); John Whitworth, Millbrae, CA (US)

(73) Assignee: MJNN LLC, South San Francisco, CA (US)

(21) Appl. No.: 17/657,122

(22) Filed: Mar. 29, 2022

Related U.S. Application Data
(63) Continuation-in-part of application No. 16/406,536, filed on May 8, 2019.

(51) Int. Cl. A01G 31/06; B08B 1/00; B08B 1/02; B08B 5/02; B08B 13/00

(52) U.S. Cl. CPC A01G 31/06; B08B 1/001; B08B 1/02; B08B 5/023; B08B 13/00

(57) ABSTRACT

A plant support tower cleaning system for cleaning a plant support tower is provided. A drive actuator propels the tower through the tower cleaning system. One or more linear or rotating first structures each have at least one projection. One or more first actuators coupled to the one or more first structures push the at least one projection of the one or more first structures against a stem side of plant material in containers in the tower as the tower is propelled through the system. A rotating second structure has at least one circumferential projection to pull plant material from a root side of the plant containers as the tower is propelled through the system. A second actuator rotates the second structure.

### CROSS-REFERENCE TO RELATED APPLICATIONS

This application is a continuation-in-part of U.S. application Ser. No. 16/406,536, filed 8 May 2019, and incorporated by reference herein.

### FIELD OF THE INVENTION

The present disclosure relates generally to growing systems and, more particularly, to a device and system configured to clean a plant support tower between use cycles.

### BACKGROUND OF THE INVENTION

Given the continued growth of the world's population, and given that the regions allocated for agricultural pursuits have decreased or simply become less favorable to such activities, the ability of conventional farms to feed the world's growing population has become increasingly taxed. Additionally, since population centers and agricultural centers are frequently not co-located, and due to the time and expense associated with shipping agricultural goods, in many regions of the world only the wealthy are able to obtain adequate supplies of non-processed food, i.e., raw fruits and vegetables. Furthermore, the fruits and vegetables that do reach population centers are likely to be of decreased nutritional content and flavor, both due to the distance that they have traveled and the fact that much of today's produce is bred for durability and fertility rather than flavor and nutrition. As a result, there has been a renewed interest in soilless growing techniques that do not require the use of pesticides, drastically reduce the use of water, and allow for growing varietals that are bred for nutrition and flavor instead of durability.

Hydroponics is a soilless growing technique in which plants are grown using a liquid solution of water and nutrients. The roots of the plants are typically maintained in a fibrous or granular material, often comprised of plastic, and fed via a wick, drip, nutrient film, or other nutrient delivery system. Hydroponic growing systems are often established within indoor facilities, thus allowing them to be located in or near population centers. This approach also provides exceptional climate control (i.e., temperature, humidity, air flow, CO₂ concentration, light wavelength, intensity and duration, etc.) as well as improved pest and disease control, thus allowing an indoor hydroponic farm to succeed in a region in which the outside environment and/or the soil conditions are inhospitable to the use of conventional farming techniques. Furthermore, hydroponic and other soilless (or nearly soilless) growing techniques can yield extremely high plant densities, especially in those instances in which either horizontal stacking systems or vertical growth towers are used.

While hydroponic and other low-soil farming techniques offer a number of advantages over conventional farming techniques, in order to achieve large-scale adoption of these techniques it is vital that the cost per plant be competitive with the costs associated with conventional farming techniques. Accordingly, the present disclosure provides an apparatus that simplifies grow tower maintenance between use cycles.

### SUMMARY OF THE INVENTION

According to embodiments of the disclosure, a plant support tower cleaning system configured to clean a plant support tower comprises: a drive actuator (e.g., a motor) configured to propel the tower through the tower cleaning system; one or more linear or rotating first structures, each having at least one projection; one or more first actuators coupled to the one or more first structures to push the at least one projection of the one or more first structures against a stem side of plant material in a plurality of plant containers in the tower as the tower is propelled through the tower cleaning system; a rotating second structure having at least one circumferential projection to pull plant material from a root side of the plurality of plant containers as the tower is propelled through the tower cleaning system; and a second actuator to rotate the second structure. The cleaning system is not limited to purely soilless grow towers.

According to embodiments of the disclosure, each of the one or more first structures comprises a wheel and the at least one projection comprises a plurality of circumferential projections. According to embodiments of the disclosure, the wheel includes a plurality of fourth actuators, each fourth actuator for extending a corresponding circumferential projection of the plurality of circumferential projections to which it is coupled. According to embodiments of the disclosure, each fourth actuator is disposed radially and extends its corresponding circumferential projection to push the corresponding circumferential projection against a stem side of plant material.

According to embodiments of the disclosure, the one or more first structures comprise one or more linear structures and the least one projection is extendable and retractable. According to embodiments of the disclosure, the one or more first structures are not actuated in any rotational direction.

According to embodiments of the disclosure, the rotating second structure is not actuated in any translational direction toward the tower as the tower travels through the cleaning system. According to embodiments of the disclosure, the rotating second structure comprises a wheel and the at least one projection comprises a plurality of circumferential projections

According to embodiments of the disclosure, the system further comprises: a linear or rotating third structure having at least one projection, wherein the third structure is not actuated in any rotational direction; and a third actuator coupled to the third structure to push the at least one projection of the third structure against the stem side of plant material to loosen plant material in the plurality of plant containers as the tower is propelled through the tower cleaning system.

According to embodiments of the disclosure, the third structure comprises a wheel and the at least one projection is a plurality of circumferential projections. According to embodiments of the disclosure, the third structure is a linear structure and the least one projection of the third structure is extendable and retractable. According to embodiments of the disclosure, the third structure is closer than the first structure to a leading edge of the tower as the tower initially approaches the system as the tower is propelled through the system, the system further comprising a controller configured to actuate the third actuator before actuating the one or more first actuators.

According to embodiments of the disclosure, the system comprises an air blower, wherein the controller is configured to cause the air blower to direct a jet of air towards the tower after a leading edge of the tower has passed at least one of the one or more first structures as the tower is propelled through the tower cleaning system.

According to embodiments of the disclosure, the system comprises a position sensor configured to detect the tower, wherein a controller is configured to actuate the first actuator in response to the sensor detecting the tower.

According to embodiments of the disclosure, the system comprises at least one idler element to limit upward motion of the plurality of plant containers as the tower is propelled through the tower cleaning system.

According to embodiments of the disclosure, the system comprises at least one tower alignment element configured to contact a first side of the tower and maintain alignment of the tower.

According to embodiments of the disclosure, the system comprises the plant support tower comprises (i) a tower body, the tower body defining at least a first tower cavity, (ii) a first tower face plate, wherein the first tower face plate is coupled to the tower body, and the first tower face plate is positionable relative to the tower body in at least a first tower cavity closed position and a first tower cavity unclosed position, and (iii) the first tower face plate includes the plurality of plant containers.

According to embodiments of the disclosure, a plant support tower cleaning system is provided that is configured to clean a multi-piece, hinged, plant support tower, where the plant support tower is comprised of (i) a tower body that defines at least a first tower cavity, where a first edge portion of the tower body includes a first tower body hinge member; (ii) a first tower face plate, where an edge portion of the first tower face plate includes a first face plate hinge member, where the first tower face plate is hingeably coupled to the tower body via the first tower body hinge member and the first face plate hinge member, where the first tower face plate is positionable relative to the tower body in at least a first tower cavity closed position and a first tower cavity open position, and where the first tower face plate includes a first plurality of plant container cut-outs; (iii) a first fastener configured to temporarily latch the first tower face plate to the tower body when the first tower face plate is in the first tower cavity closed position; and (iv) a first plurality of plant containers attached to the first tower face plate via the first plurality of plant container cut-outs. The plant support tower cleaning system is comprised of (i) a drive system that propels the multi-piece plant support tower through the plant support tower cleaning system; (ii) an alignment system that aligns the multi-piece plant support tower body within the plant support tower cleaning system; (iii) a brush unit configured to brush the multi-piece plant support tower as it is propelled through the plant support tower cleaning system; and (iv) a plunger unit configured to expel growth media and plant debris from the first plurality of plant containers as the multi-piece plant support tower is propelled through the plant support tower cleaning system. The plant support tower cleaning system may further include an air blower configured to direct a jet of air towards the multi-piece plant support tower after the multi-piece plant support tower has passed the brush unit and the plunger unit and as it is propelled through the plant support tower cleaning system.

In one aspect of the disclosure, the brush unit may include a first rotating brush that is configured to brush a plurality of plant container surfaces adjacent to an inside surface of the first tower face of each of the first plurality of plant containers. The brush unit may further include a second rotating brush that is configured to brush an outside surface of the first tower face.

In another aspect, the plunger unit may include a plunger that is configured to controllably alternate between a withdrawn position and an extended position. In the withdrawn position the plunger allows passage of the multi-piece plant support tower and the first plurality of plant containers. In the extended position the plunger extends at least partially into each plant container of the first plurality of plant containers as the multi-piece plant support tower is propelled through the plant support tower cleaning system. The plunger unit may further include a plant container position sensor that is configured to monitor the position of each of the plant containers relative to the plunger unit and to activate the plunger unit (i.e., extend the plunger) as each plant container is aligned with the plunger unit. The plunger may be pneumatically, hydraulically or electrically driven.

In another aspect, the cleaning system may further include a plurality of idler rollers comprised of at least one upper idler roller configured to limit upward motion of the first tower face plate as the multi-piece plant support tower is propelled through the plant support tower cleaning system, and of at least one lower idler roller configured to limit downward motion of the first tower face plate as the multi-piece plant support tower is propelled through the plant support tower cleaning system. The at least one upper idler roller may include a first upper idler roller located before the brush unit, a second upper idler roller located after the brush unit and before the plunger unit, and a third upper idler roller located after the plunger unit. The at least one lower idler roller may include a first lower idler roller located before the brush unit, a second lower idler roller located after the brush unit and before the plunger unit, and a third lower idler roller located after the plunger unit.

In another aspect, the cleaning system may further include at least one set of tower body alignment rollers comprised of a first tower body alignment roller and a second tower body alignment roller, where the first tower body alignment roller is located on a first side of the tower body and configured to locate and align the first side of the tower body, and where the second tower body alignment roller is located on a second side of the tower body and configured to locate and align the second side of the tower.

In another aspect, the drive system may include at least one drive roller coupled to a drive motor and configured to contact the tower body along at least a first tower body side. Operation of the drive motor forces rotation of the at least one drive roller, thereby propelling the multi-piece plant support tower through the plant support tower cleaning system. The drive system may further include at least one secondary drive roller, which is not coupled to the drive motor, and which is configured to contact the tower body along at least a second tower body side.

In another aspect, the multi-piece plant support tower may include (i) a first modified V-shaped groove running along the length of the first side of the tower body, the first modified V-shaped groove comprising a first inner groove wall, a first sloped groove wall that couples the first edge of the first inner groove wall to the first edge of the first side of the tower body, and a second sloped groove wall that couples the second edge of the first inner groove wall to the second edge of the first side of the tower body; and (ii) a second modified V-shaped groove running along the length of the second side of the tower body, the second modified V-shaped groove comprising a second inner groove wall, a third sloped groove wall that couples the first edge of the second inner groove wall to the first edge of the second side of the tower body, and a fourth sloped groove wall that couples the second edge of the second inner groove wall to the second edge of the second side of the tower body. The first inner groove wall may be substantially parallel to the first side of the tower body and substantially perpendicular to the first tower cavity rear wall, and the second inner groove wall may be substantially parallel to the second side of the tower body and substantially perpendicular to the first tower cavity rear wall. The drive system may include a plurality of drive rollers including at least a first drive roller and a second drive roller, where the first drive roller is coupled to a drive motor and configured to contact the tower body within the first modified V-shaped groove. Operation of the drive motor forces rotation of the first drive roller, thereby propelling the multi-piece plant support tower through the plant support tower cleaning system. The second drive roller is not coupled to the drive motor and is configured to contact the tower body within the second modified V-shaped groove. The second drive roller may be mounted via a pneumatic or spring coupler and configured to apply pressure to the tower body via the second inner groove wall.

In another aspect, the multi-piece plant support tower may be a dual-sided plant support tower with the tower body defining first and second tower cavities. In this configuration the first body hinge member of the first edge portion of the tower body corresponds to the first tower cavity. A second tower body hinge member of a second edge portion of the tower body corresponds to the second tower cavity. The dual-sided plant support tower further comprises (i) a second tower face plate, where an edge portion of the second tower face plate includes a second face plate hinge member, where the second tower face plate is hingeably coupled to the tower body via the second tower body hinge member and the second face plate hinge member, where the second tower face plate is positionable relative to the tower body in at least a second tower cavity closed position and a second tower cavity open position, and where the second tower face plate includes a second plurality of plant container; (ii) a second fastener configured to temporarily latch the second tower face plate to the tower body when the second tower face plate is in the second tower cavity closed position; and (iii) a second plurality of plant containers attached to the second tower face plate via the second plurality of plant container cut-outs. The brush unit in this dual-sided configuration includes a first rotating brush configured to brush a first plurality of plant container surfaces of each of the first plurality of plant containers and a second rotating brush configured to brush a second plurality of plant container surfaces of each of the second plurality of plant containers. The plunger unit in this dual-sided configuration is configured to expel growth media and plant debris from both the first and second pluralities of plant containers as the multi-piece plant support tower is propelled through the plant support tower cleaning system. In this dual-sided configuration, preferably the first modified V-shaped groove is centered between the first tower cavity and the second tower cavity, and the second modified V-shaped groove is centered between the first tower cavity and the second tower cavity. The first inner groove wall may be substantially parallel to the first side of the tower body and substantially perpendicular to the first tower cavity rear wall, and the second inner groove wall may be substantially parallel to the second side of the tower body and substantially perpendicular to the second tower cavity rear wall.

A further understanding of the nature and advantages of embodiments of the disclosure may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. The same reference label on different figures should be understood to refer to the same component or a component of similar functionality. Additionally, multiple labels using the same numerical label and differing only in the letter label (e.g., 1411A and 1411B) refer to components of the same or similar functionality but located in different locations within the device (e.g., left and right configured components that are of the same general design and perform the same general function).

FIG. 1 provides a perspective view of an exemplary dual-sided, multi-piece plant support tower with hingeably coupled front face plates, this view showing the face plates in the closed position;

FIG. 2 provides a perspective view of the dual-sided, multi-piece plant support tower shown in FIG. 1, this view showing the face plates in the open position;

FIG. 3 provides a front planar view of a portion of a plant support tower containing several plant plug holders;

FIG. 4 provides a side cross-sectional view of the tower assembly shown in FIG. 3;

FIG. 5 provides the same view as that shown in FIG. 4, with the inclusion of a plant plug within one of the plant plug holders;

FIG. 6 provides a cross-sectional view of a preferred configuration for a multi-piece tower assembly for use with embodiments of the disclosure, this view showing both face plates in the open position;

FIG. 7 provides a cross-sectional view of the preferred configuration for the multi-piece tower assembly shown in FIG. 6, this view showing both face plates in the closed position;

FIG. 8 provides a diagram of the basic operational units of the opening apparatus in accordance with embodiments of the disclosure;

FIG. 9 illustrates the drive unit of the tower opening system of embodiments of the disclosure, this figure providing a simplified cross-sectional view of the multi-piece tower assembly shown in FIG. 7 along with a pair of drive rollers;

FIG. 10 provides a simplified top-down view of a first configuration for the drive system of embodiments of the disclosure;

FIG. 11 provides a simplified top-down view of a second configuration for the drive system of embodiments of the disclosure;

FIG. 12 provides a simplified top-down view of a third configuration for the drive system of embodiments of the disclosure;

FIG. 13 provides a simplified top-down view of a drive unit utilizing two drive rollers;

FIG. 14 provides a simplified top-down view of a drive unit utilizing two drive rollers as well as an alignment roller;

FIG. 15 illustrates a pair of alignment rollers relative to the multi-piece tower assembly shown in FIG. 9, this figure providing a simplified cross-sectional view of the assembly;

FIG. 16 provides a simplified side view of the cleaning apparatus in accordance with embodiments of the disclosure;

FIG. 17 provides a simplified end view of the assembly that illustrates the use of constraining rollers to maintain tower face plate and plant container position in the multi-piece tower assembly shown in FIGS. 9 and 13, this view not including alignment rollers, drive rollers or any of the cleaning system components;

FIG. 18 provides a simplified end view of the assembly that illustrates the rotating brushes of the cleaning system;

FIG. 19 illustrates operation of the plunger unit; and

FIGS. 20A-20D illustrate operation of the plant container position sensor that is used to trigger operation of the corresponding plunger unit.

FIGS. 21A-21D are a sequence of side-view drawings illustrating a tower cleaning system, according to embodiments of the disclosure. FIG. 21A1 illustrates an opposite side view of the tower cleaning system 2100.

FIG. 22 illustrates a perspective view of a tower cleaning system in a retracted configuration, according to embodiments of the disclosure.

FIG. 23 illustrates a perspective view of a tower cleaning system in a retracted configuration for a double-sided tower, according to embodiments of the disclosure.

FIGS. 24A-24B are side-view drawings of a tower cleaning system 2400, according to embodiments of the disclosure.

FIGS. 25A, 25B, and 25C show the first wheel in side, end, and isometric views, respectively, for cleaning a double-sided tower, according to embodiments of the disclosure.

FIGS. 26A and 26B show, respectively, a transparent isometric view and a cross-sectional view of the first wheel with linear actuators and air holes, according to embodiments of the disclosure.

FIGS. 27A and 27B show rear isometric transparent and solid views, respectively, of an inner bearing. FIGS. 27C and 27D show front isometric transparent and solid views, respectively, of the inner bearing, according to embodiments of the disclosure.

FIG. 28 illustrates the tower cleaning system with a fixed stationary surface to enable retraction of the plungers, according to embodiments of the disclosure.

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure.

In accordance with embodiments of the disclosure, an apparatus is disclosed that provides a means for automatically cleaning and removing plant and material debris from within a hinged, plant support tower, and more particularly, from within the plant containers contained within such a plant support tower. As plant and material debris is often difficult to remove, it is important to utilize a debris removal process, such as that described herein, prior to washing the tower, thereby ensuring that the plant support tower and plant containers are completely clean before initiating the tower re-planting step.

As described in detail below, the tower cleaning and debris removal apparatus of embodiments of the disclosure is comprised of several primary components: (i) a drive system that forces the tower through the apparatus; (ii) an alignment system that ensures that the tower remains in proper alignment throughout the cleaning process; (iii) a brush system that initiates separation of plant debris from the tower/plant containers and ensures that the plant roots are torn apart; (iv) a plunger system to eject plant debris from within the plant containers; (v) an air delivery system to blow away the debris; and (vi) rollers to maintain tower face alignment during the cleaning process. Preferably the apparatus also includes means for containing the debris that is removed from the tower.

The tower cleaning and debris removal apparatus of embodiments of the disclosure can be configured to work with a variety of tower designs. In order to clarify operation of the disclosed system, embodiments of the disclosure are illustrated using the dual-sided, multi-piece plant support tower described in co-pending and co-assigned U.S. patent application Ser. No. 15/968,425, filed 1 May 2018, the disclosure of which is incorporated herein for any and all purposes. It should be understood, however, that the present invention may also be configured for use with a single-sided, multi-piece plant support tower such as that disclosed in U.S. patent application Ser. No. 15/968,425, as well as other hydroponic and non-hydroponic tower designs, and therefore the description and illustrated embodiments contained herein should not be viewed as limiting the disclosed cleaning apparatus to a particular type of tower. In particular, although the designs herein may be applied to hydroponic towers, they also apply to towers used for non-hydroponic purposes.

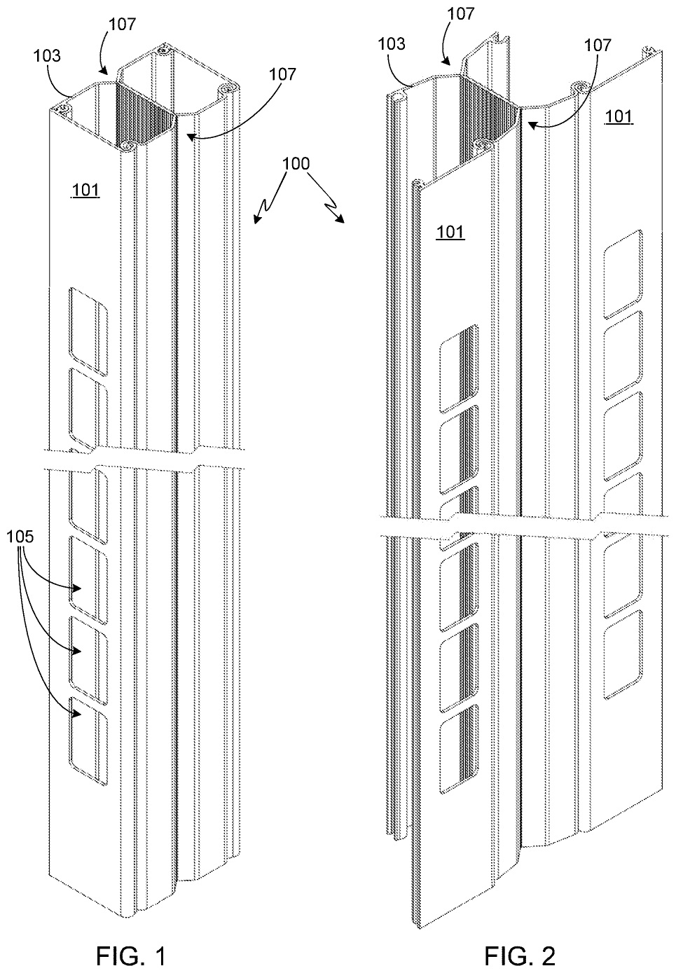

FIGS. 1 and 2 provide perspective views of an exemplary dual-sided, multi-piece plant support tower 100 in which each front face plate 101 is hingeably coupled to the tower body 103, this configuration being described in detail in U.S. patent application Ser. No. 15/968,425. In FIG. 1 each front face plate 101 is in the closed position while in FIG. 2 face plates 101 are shown in the open position. Although any of a variety of materials can be used in the manufacture of the tower, preferably the tower is fabricated from plastic (e.g., polyethylene, polypropylene, polyvinyl chloride (PVC), polytetrafluoroethylene, acrylonitrile butadiene styrene (ABS), etc.). In at least one embodiment, the tower body is fabricated from a PVC plastic and the tower face plates are fabricated from an ABS plastic. Preferably the materials used to fabricate the tower are opaque in order to prevent light from entering the tower, thus helping to minimize algae growth. Additionally, in at least one configuration the tower materials are white, thereby increasing the amount of light reflected back onto the plants.

In FIGS. 1 and 2, tower 100 includes a plurality of cut-outs 105. Each cut-out 105 is shaped and sized to accommodate the intended plant plug holder, also referred to herein as a plant container (not shown in FIGS. 1 and 2). A variety of designs and configurations may be used for the individual plant plug holders. Exemplary plant plug holders are described in detail in co-assigned and co-pending U.S. patent application Ser. No. 15/910,445, filed 2 Mar. 2018, and U.S. patent application Ser. No. 15/910,796, filed 2 Mar. 2018, the disclosures of which are incorporated herein for any and all purposes. It should be understood, however, that the tower cleaning apparatus disclosed in the present application is not limited to use with a particular plant plug holder, although clearly the location and engagement angles of the various cleaning devices (e.g., brushes, plungers and blowers) should be configured to match the intended plant plug holders.

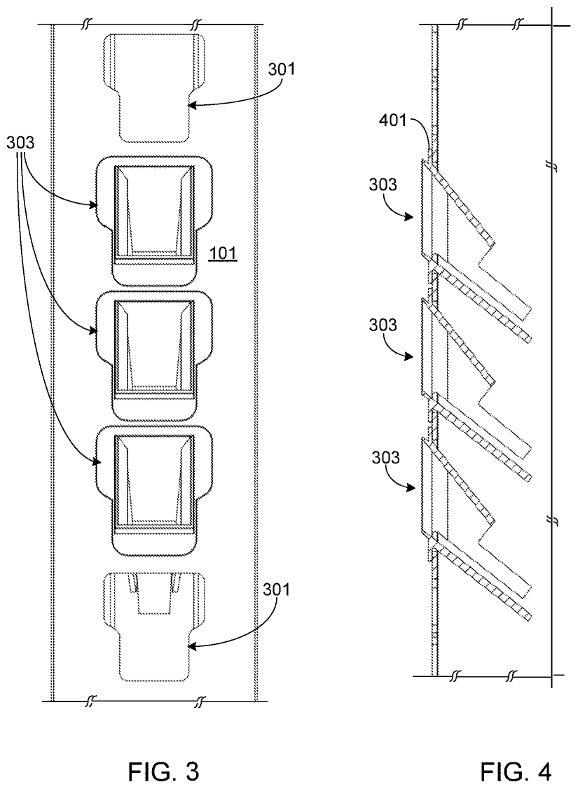

FIG. 3 provides a front planar view of a portion of a plant support tower assembly utilizing an alternate cut-out design 301. In this figure plant containers (plug holders) 303, such as those employed in the exemplary configuration illustrated in the present application, are shown inserted within the three middle cut-outs 301 while the uppermost and lowermost cut-outs 301 are shown open. According to embodiments of the disclosure, the plant containers 303 may be integrated (e.g., molded, integrally formed) into tower 100, which may obviate the need for distinct cut-outs.

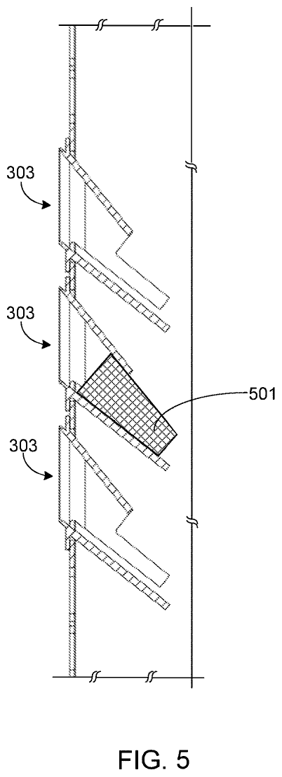

FIG. 4 provides a vertical cross-sectional view of the portion of the tower assembly shown in FIG. 3. FIG. 5 provides the same cross-sectional view as that shown in FIG. 4, with the addition of a plant plug 501 within the middle plant plug holder 303. Note that in FIG. 5 only the plant plug is shown, i.e., there is no seedling, mature plant or root structure contained within plug 501. Additionally, note that FIGS. 4 and 5 only illustrate one side of a dual-sided plant support tower such as the tower shown in FIGS. 1 and 2.

The plant plug holders used with embodiments of the disclosure are preferably fabricated from plastic (e.g., polyethylene, polypropylene, polyvinyl chloride (PVC), polytetrafluoroethylene, acrylonitrile butadiene styrene (ABS), etc.), for example using injection molding. As with the tower face plates, preferably the plant plug holders are manufactured using an opaque plastic (e.g., ABS) that is colored white to minimize algae growth within the tower and increase reflected light.

Typically the plant plug holders, e.g., holders 303, are attached to tower face 101 via edge member 401, where edge member 401 encircles the plant container opening as shown. Edge member 401 extends out and away from the sides of the plug holder, thereby allowing the back surface of the edge member to be sealed to the tower face. While the plug holder does not have to be sealed to the tower face, sealing is preferred in order to inhibit leaking between the two components. Preferably the seal completely circumscribes the plant container opening. Although a variety of techniques can be used to seal the two components together, preferably they are either bonded together (e.g., solvent bonding) or welded together (e.g., ultrasonic welding).

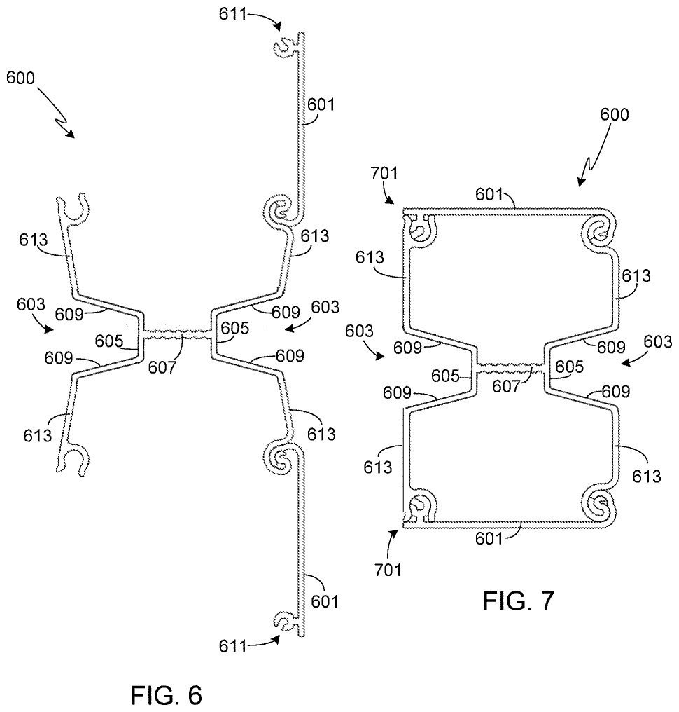

In tower 100, a large “V” shaped groove 107 runs along the length of the tower, and on either side of the tower as shown in FIGS. 1 and 2. Preferably groove 107 is centered on the side of tower, evenly splitting the two tower cavities. If the present invention is used with a single-sided tower, preferably the tower still includes a groove, thereby providing a simplified means for tower alignment. While embodiments of the disclosure can be used with a tower that utilizes a V-shaped groove, preferably a modified groove shape is employed as illustrated in FIGS. 6 and 7.

FIGS. 6 and 7 provide cross-sectional views of a preferred multi-piece, hinged tower 600. For clarity, plant plug holders are not shown affixed to the tower in these figures. In FIG. 6 face plates 601 are shown in an open position while in FIG. 7 the face plates are shown in a closed position. Preferably both the body portion and the face plates are extruded, and features such as the plant container cut-outs are punched during the process. As shown, the cross-section of tower 600 is slightly different from that of tower 100. Specifically, rather than a simple “V” shaped groove, modified groove 603 includes an inner groove wall 605 which, due to rear tower cavity wall 607, exhibits improved rigidity in this region of the groove. Sloped groove walls 609 of modified groove 603 retain a V-shape as in the previously described and illustrated tower grooves. The hinged tower faces 601 are substantially the same, if not identical, to the tower faces 101 of tower 100 and operate in the same manner as those described in U.S. patent application Ser. No. 15/968,425. In the preferred embodiment, each face plate is attached to the body of the plant support tower using snap-fit fasteners 701.

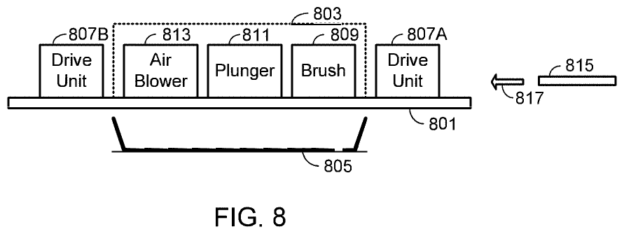

FIG. 8 provides a diagram of the basic operational units of the cleaning apparatus in accordance with embodiments of the disclosure. Preferably the cleaning apparatus is washdown safe (i.e., built to IP65 or higher standards) in order to simplify cleaning and maintenance. In at least one embodiment, the operational units are attached to a mounting base 801, thus providing stability and rigidity to the overall structure and ensuring that the various components of the system remain aligned. To contain the plant material and other debris ejected from the tower during cleaning, preferably the apparatus, or at least those portions of the apparatus that actively clean the tower (e.g., brushes, plungers and air blowers), are housed within a hood 803. Additionally the system preferably includes a debris collector 805 into which the debris ejected from the tower during cleaning is caught, thereby simplifying debris disposal while maintaining the cleanliness of the work station.

The system described herein utilizes a drive unit to propel the plant support tower through the cleaning apparatus. The drive unit can be located before the cleaning system and used to push the tower through the cleaner. Alternately, the drive unit can be located after the cleaning system and used to pull the tower through the cleaner. In the preferred configuration, however, a pair of drive units 807A and 807B is used to both push and pull the tower, respectively, through the cleaning system. In addition to propelling the tower through the cleaning system, the drive unit(s) also aids in ensuring proper alignment of the tower relative to the cleaning system. The cleaning system includes a brush unit 809, a plunger unit 811 and an air blower 813. Note that in the illustrated embodiment, a tower assembly 815 enters the cleaning system from the right and passes through the system in a direction 817.

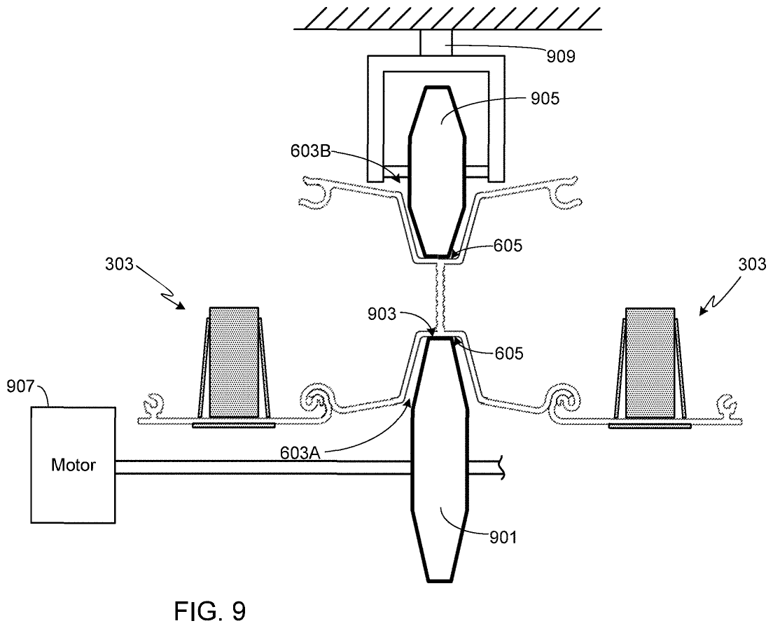

In embodiments of the disclosure, drive rollers are pressed against the face of wall 605 of the modified V-shaped groove that runs the length of the tower body. FIG. 9 provides a preferred configuration for a drive system, this figure showing the dual-sided tower with the modified V-shaped groove 603 shown in FIGS. 6 and 7 with plant containers 303 in place. As illustrated, a drive roller 901 fits within one of the tower's grooves 603 such that the face 903 of drive roller 901 presses against wall 605 of groove 603A. Preferably face 903 of drive roller 901 is substantially flat, thereby providing greater contact area with wall 605 of the groove. A second drive roller 905 presses against wall 605 of groove 603B, where grooves 603A and 603B are complimentary modified V-shaped grooves located on either side of the tower body. One of the drive rollers (e.g., drive roller 901) is coupled to a drive motor 907 while the second drive roller (e.g., drive roller 905) is preferably not driven and is used to apply pressure against the tower, thus ensuring that the drive wheel coupled to the motor remains in contact with wall 605 of the groove and that rotation of the motorized drive wheel forces forward movement of the tower through the tower opening apparatus. The second drive roller is preferably coupled to a tensioner 909 (e.g., pneumatic or spring coupler) in order to ensure that sufficient force is applied by the second drive roller, thereby forcing the tower against the motorized drive roller. The motorized drive roller, and in some embodiments both drive rollers, is fabricated from a material with a relatively high coefficient of friction. Typically a polyurethane material is used for the motorized drive roller, and in some cases for both drive rollers, with a kinetic coefficient of friction that is preferably greater than 1. In some applications a material with a high coefficient of friction (e.g., polyurethane, rubber, etc.) is applied to the outer layer of the drive roller(s).

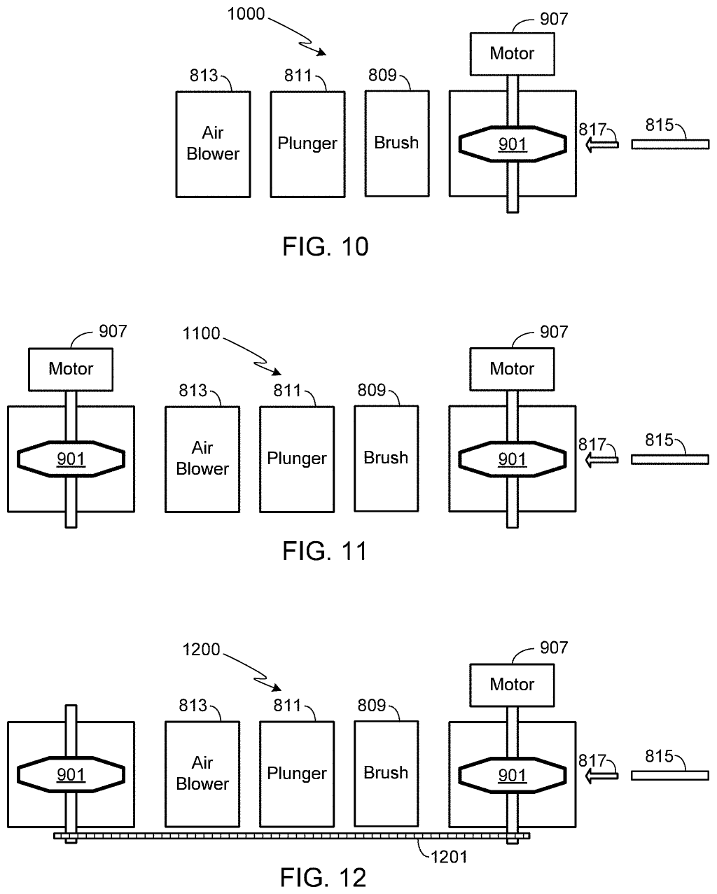

As previously noted, while utilizing the basic operational units of the tower cleaning system, the present invention can be modified to accommodate various tower configurations, thus allowing the system to be used with plant support towers of different dimensions, different alignment groove configurations, various hinge mechanisms and both dual and single-sided towers. FIGS. 10-12 provide simplified top-down views of three different configurations for the drive unit of embodiments of the disclosure, each using drive rollers as described above and illustrated in FIG. 9. Exemplary configuration 1000 uses a single drive unit located at the entrance to the cleaning apparatus. Exemplary configurations 1100 and 1200 utilize dual drive units, one located at the entrance to the cleaning apparatus and one located at the apparatus exit. In configuration 1100, each drive unit is coupled to its own motor 907. In configuration 1200, a single motor is coupled to both drive units, one directly and one indirectly via a belt drive 1201. Preferably belt drive 1201 utilizes a metal chain belt, an elastomer v- or multi-ribbed belt, or a polyurethane v- or multi-ribbed-belt.

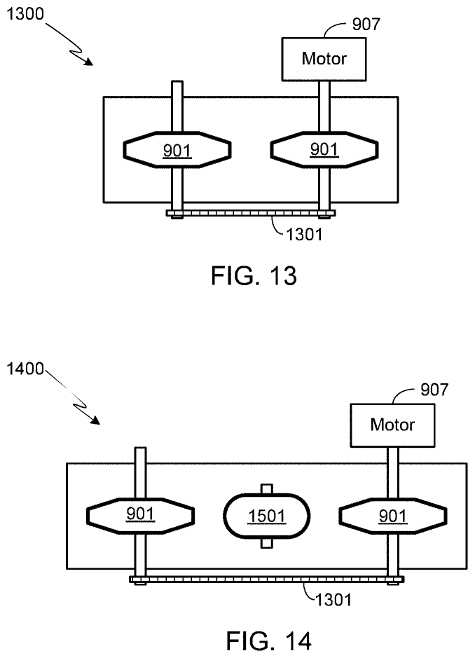

Regardless of whether the system of embodiments of the disclosure utilizes a drive unit before the cleaning system, after the cleaning system, or both before and after the cleaning system, it should be understood that each drive unit(s) can utilize a single drive roller or multiple drive rollers. For example, FIG. 13 illustrates a drive unit 1300 that utilizes a pair of drive rollers 901, this unit being capable of working before, after, or both before and after the cleaning system. Similarly, FIG. 14 illustrates a drive unit 1400 that utilizes a pair of drive rollers 901 as well as an alignment roller 1501, the alignment roller being described in detail below. Preferably belt drive 1301 utilizes a metal chain belt, an elastomer v- or multi-ribbed belt, or a polyurethane v- or multi-ribbed-belt.

Those skilled in the art will recognize that instead of the active rollers described herein, such as the drive rollers, the system may employ other active conveyance elements such as gears, wheels, belts, or treads. Those skilled in the art will recognize that instead of the passive rollers described herein, such as the alignment rollers and the idler rollers, the system may employ other passive conveyance elements such as a low-friction bearing surface, e.g., a linear bearing (e.g., comprising a plastic material, such as a thermoplastic such as an ultra-high molecular weight plastic (UHMW) or DELRIN®) to allow the tower to slide against the passive elements. Further disclosure of a tower drive mechanism of embodiments of the disclosure including active and passive conveyance elements may be found in PCT/US20/15921, filed 30 Jan. 2020, published as WO2021/055001 A1 on 25 Mar. 2021, and incorporated by reference herein in its entirety.

As previously noted, in addition to drive rollers the operating apparatus of embodiments of the disclosure preferably utilizes one or more alignment rollers that ensure that the tower remains correctly aligned as it passes through the cleaning apparatus. Preferably the alignment rollers are positioned in pairs, where each pair includes an alignment roller located on one side of the tower (e.g., above the tower) and a complimentary alignment roller located on the opposing tower side (e.g., below the tower). Utilizing complementary roller pairs enhances tower stability and alignment within the cleaning apparatus. In the preferred embodiment, a first pair of complimentary alignment rollers immediately precedes the cleaning apparatus, specifically the brush unit, and a second pair of complimentary alignment rollers immediately follows the cleaning apparatus, specifically the air blower unit.

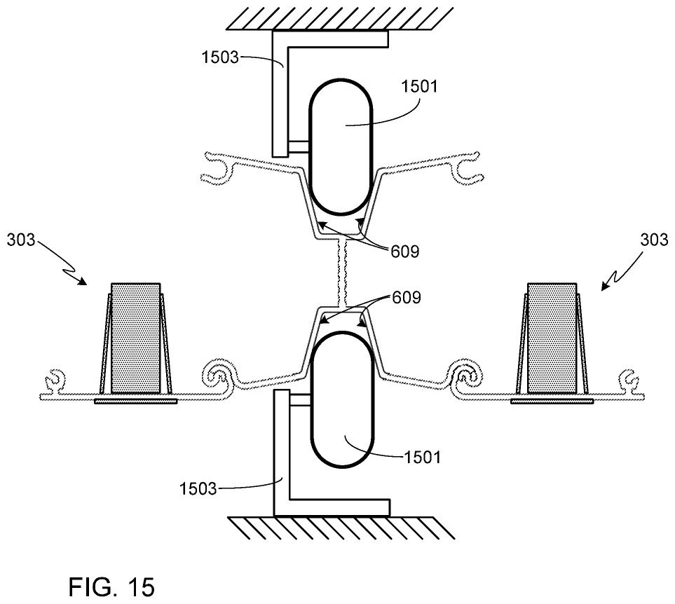

In the preferred embodiment, and as illustrated in the cross-sectional view provided by FIG. 15, the alignment rollers 1501 fit within the modified V-shaped grooves that run the length and on either side of the tower. Preferably the alignment rollers 1501 have a more rounded profile than the drive rollers, thereby contacting the sloped side walls 609 of the groove rather than groove face 605. Although the alignment rollers 1501 may be coupled to pneumatic or spring couplers in order to force contact between the roller surfaces and the tower grooves, the inventors have found that active roller mountings are not required and that the alignment rollers can be mounted using static mounts 1503 as shown. In general, the alignment rollers are mounted on axles which are supported by pillow blocks. The axles can also be supported by shaft mounts, or the wheels can be supported by shoulder bolts in a plate or similar mount. As rollers 1501 only perform the function of tower alignment, not tower motion, the inventors have found that the material used to fabricate the rollers is not critical. Preferably a plastic material, for example a thermoplastic such as Delrin®, is used to fabricate the alignment rollers.

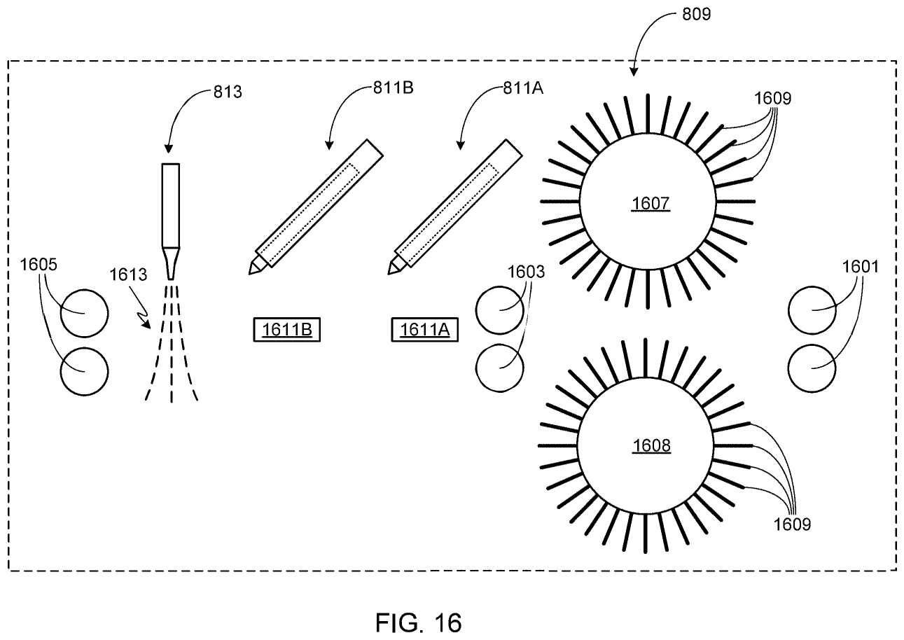

FIG. 16 provides a simplified side view of the primary components comprising the tower cleaning system of embodiments of the disclosure. As embodiments of the disclosure are configured to clean a dual-sided plant support tower as described above, it should be understood that there is a second set of cleaning components (e.g., brush, plunger and air blower components) behind those shown in FIG. 16 that are used on the adjacent, second side of the tower.

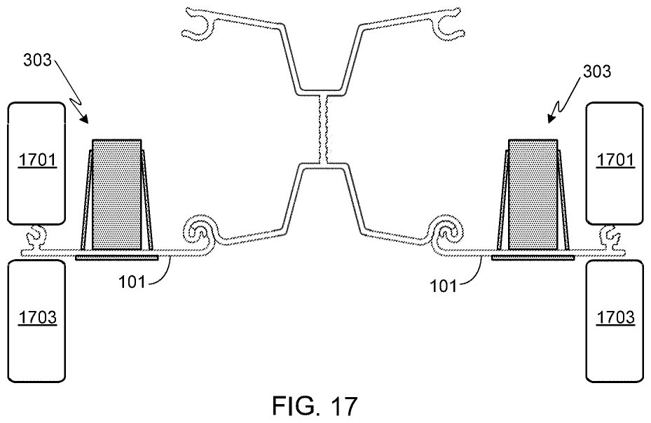

The inventors have found that the cleaning process used and described herein can occasionally cause tower movement, in particular tower face movement. Since tower face movement can cause the attached plant containers to become misaligned with the cleaning system, embodiments of the disclosure utilize several pairs of idler rollers, also referred to herein as constraining rollers. Preferably, and as shown in FIG. 16, a first pair of idler rollers 1601 is positioned immediately prior to the brushes, a second pair of idler rollers 1603 is positioned immediately after the brushes and immediately before the plunger, and a third pair of idler rollers 1605 is positioned after the air blowers and before the tower assembly leaves the cleaning system. As shown in FIG. 17, an upper idler roller 1701 ensures that the tower face plate 101 does not move in an upward direction while lower idler roller 1703 ensures that the tower face plate 101 does not move in a downward direction. In general if the tower face moves upward by more than a minimal amount, the cleaning system may not operate as intended. For example, the brushes may not interact with the tower face/plant container correctly. In some cases tower face misalignment may even cause the plunger to damage the tower face/plant container. Tower face movement in a downward direction by more than a minimal amount may not only cause misalignment between the tower face/plant container and the cleaning system, but may also lead to tower hinge damage.

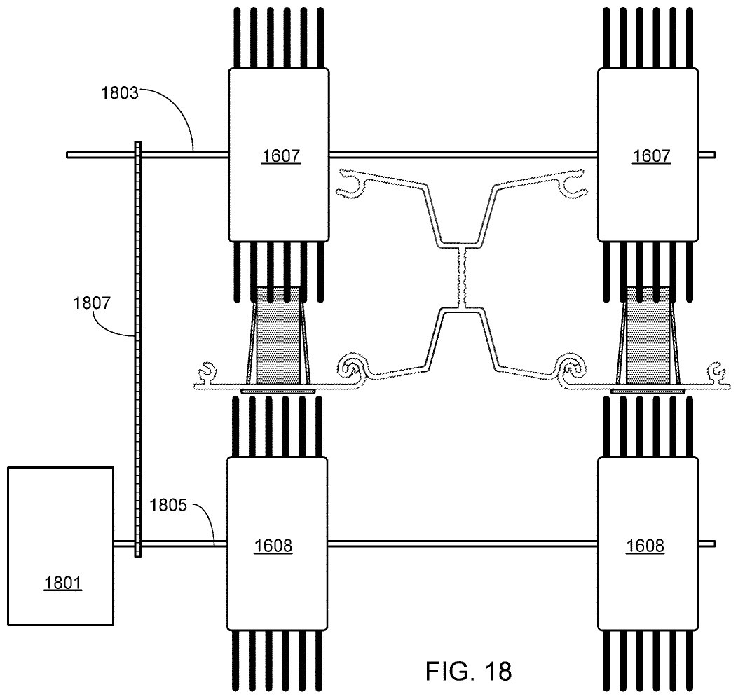

The first cleaning component of the tower cleaning system is the brush unit 809. In the preferred embodiment, each tower face is cleaned by an upper rotating brush 1607 and a lower rotating brush 1608. In an alternate embodiment, only the upper rotating brush 1607 is used in this section of the cleaning system. Each rotating brush includes a plurality of coarse bristles 1609, the bristles preferably fabricated from plastic. As the tower passes through the cleaning system, the rotating brush(s) break-up the roots sticking out from the plant plug, thereby simplifying plug removal with the plunger. FIG. 18 provides a simplified end view of the cleaning system, this view illustrating placement of the rotating brushes. Preferably both brushes, assuming the use of dual rotating brushes as preferred and illustrated, utilize a single drive motor 1801 where the brushes on axle 1803 are coupled to the brushes on axle 1805 via a belt 1807.

The second cleaning component of the tower cleaning system is the plunger unit 811. As shown in FIG. 16, the preferred embodiment includes a pair of plungers 811A and 811B for each side of the tower. Although alternate embodiments of the disclosure use a single plunger unit, other embodiments of the disclosure utilize a pair of plungers in order to provide redundancy and ensure that the plant material within each plant container 303 is removed. The plungers may be pneumatically driven, although the plungers can also utilize hydraulic or electric servo drivers.

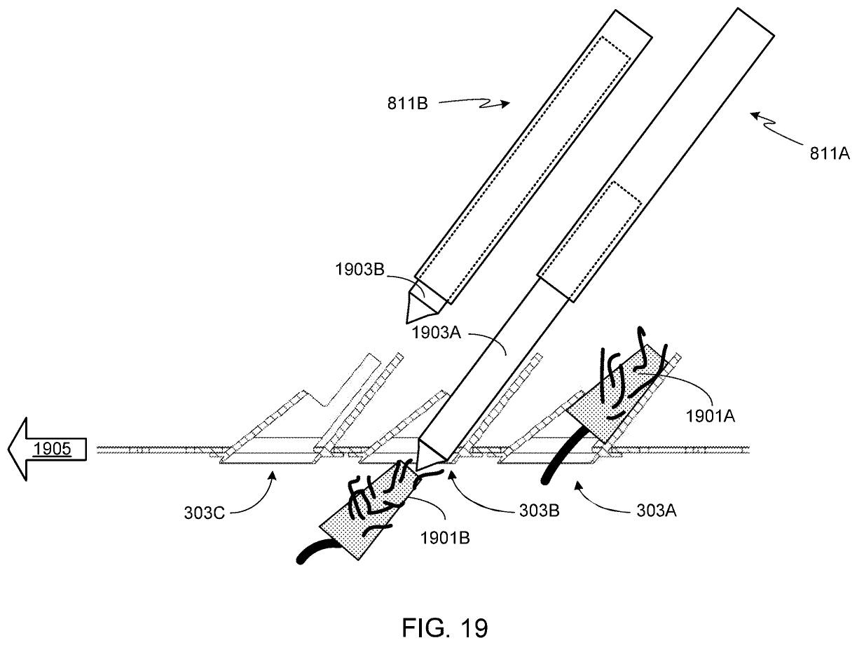

FIG. 19 provides a simplified side view of the plunger unit of the present invention, this figure illustrating operation of the plunger unit. In this figure plant containers 303A-303C are shown in cross-section with plant container 303A still full of growth media and plant material 1901A; plant container 303B in the process of being emptied of growth media and plant material 1901B; and plant container 303C already emptied of growth media and plant material. As shown, plunger 1903A is in the extended position, thereby forcibly expelling the growth media and plant material 1901B contained within plant container 303B. In contrast, plunger 1903B is shown in the withdrawn position. Note that in this figure, the tower is being driven through the cleaning system in a direction 1905.

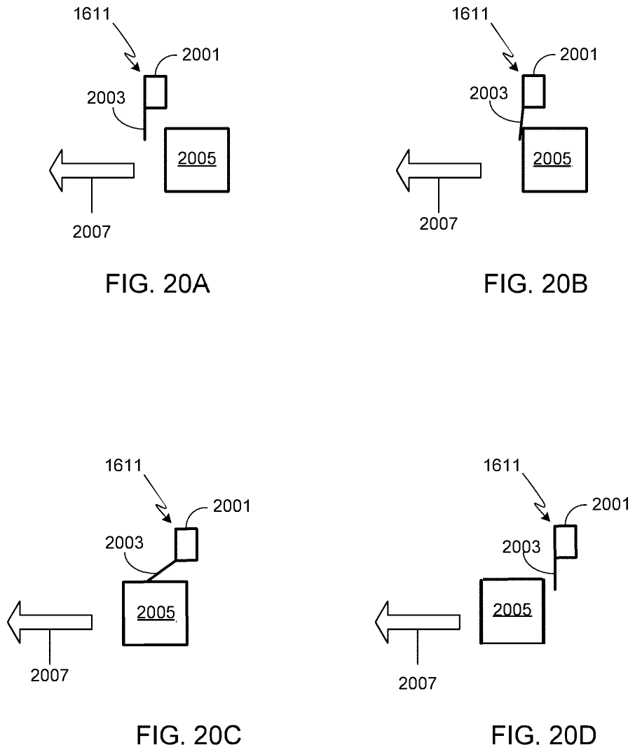

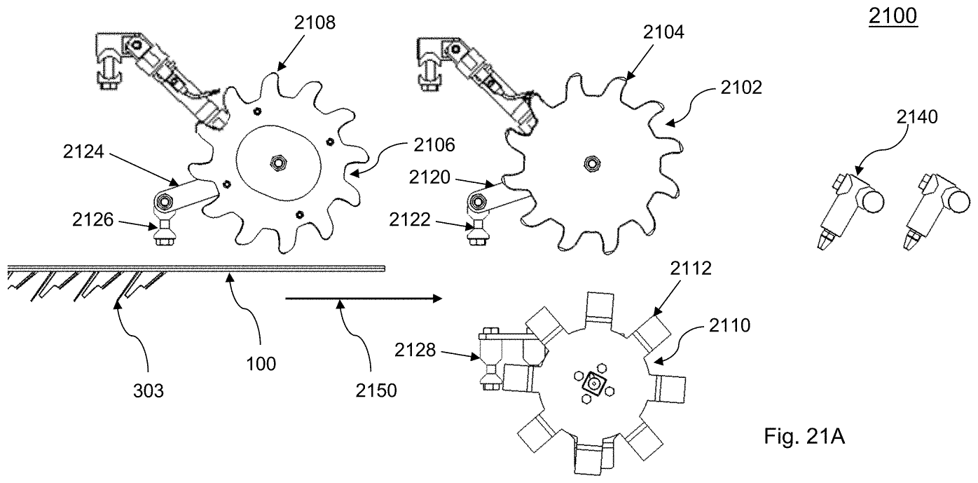

In order to correctly operate the plunger unit, a controller monitors the position of the plant containers as the tower passes through the cleaning system. By monitoring the position of the plant containers relative to the plunger units, the controller is able to correctly activate the plunger when the plant container is optimally located. FIG. 16 shows that there is a first position sensor unit 1611A proximate to plunger unit 811A, and a second position sensor unit 1611B proximate to plunger unit 811B. Although the position sensor units can utilize any of a variety of common position sensing technologies (e.g., optical, capacitive, etc.), the inventors have found that mechanical position sensors perform best when taking into account the cleaning system environment (i.e., towers covered with growth media, plant debris, moisture, etc.). FIGS. 20A-20D illustrate the operation of the preferred configuration for the plant container sensor. In these figures, sensor 1611 is comprised of a sensor switch 2001 and a sensing member 2003. FIG. 20A shows a plant container 2005 approaching the position sensor. As the plant container moves forward in a direction 2007, an edge of the plant container hits sensing member 2003 (FIG. 20B). As plant container 2005 continues to move forward, sensing member 2003 continues to rotate about sensor switch 2001, eventually rotating far enough to trigger the switch (FIG. 20C). At this point the plunger unit that corresponds to this particular position sensor is activated. Then, as plant container 2005 continues to move forward, the sensing member rotates back to the sensor's initial, pre-strike position (FIG. 20D), ready to sense the passing of the next plant container.

The last stage of the cleaning system is air blower 813. Air blower 813 directs a jet of air 1613 towards the passing tower, thereby blowing off growth media and plant material that may have come to rest on a portion of the tower after the brushing and plunging operations. Preferably after the tower passes through the cleaning system, it passes through a washer that washes the tower and attached plant containers prior to the plant containers being replanted.

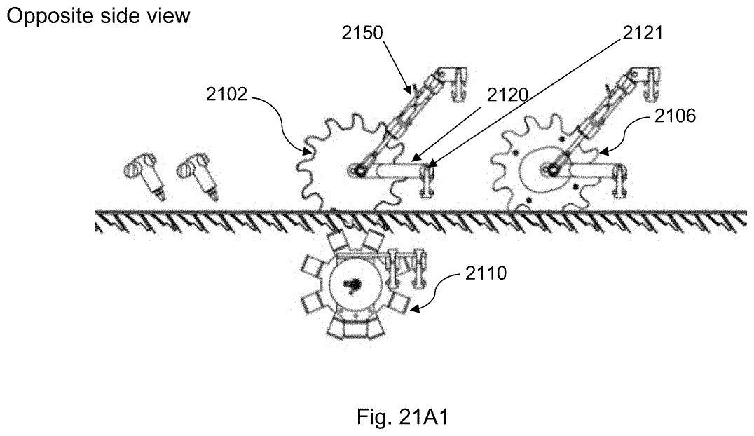

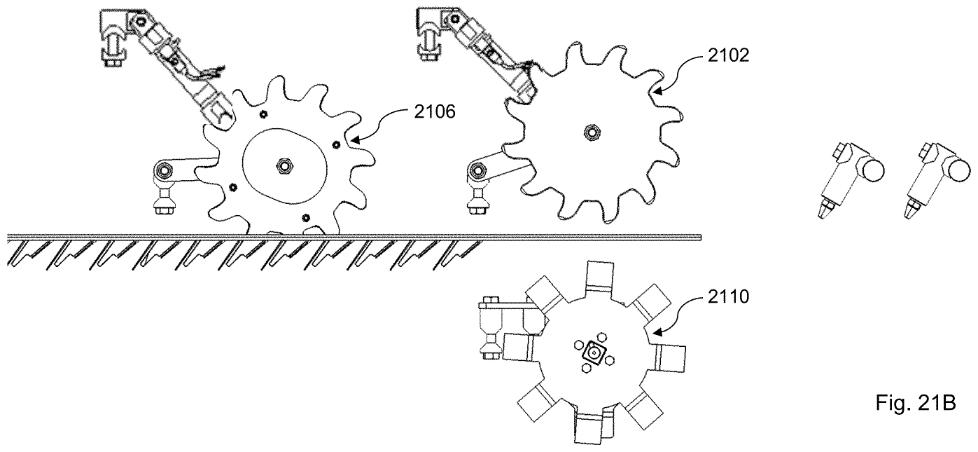

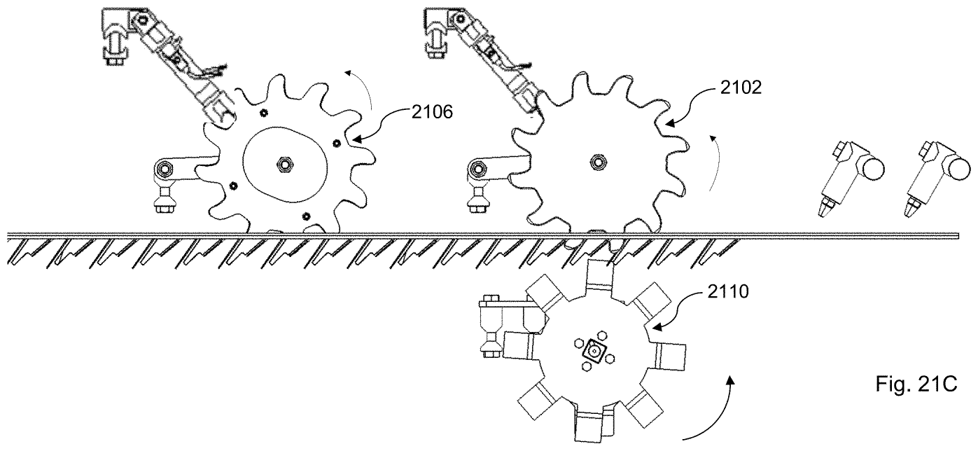

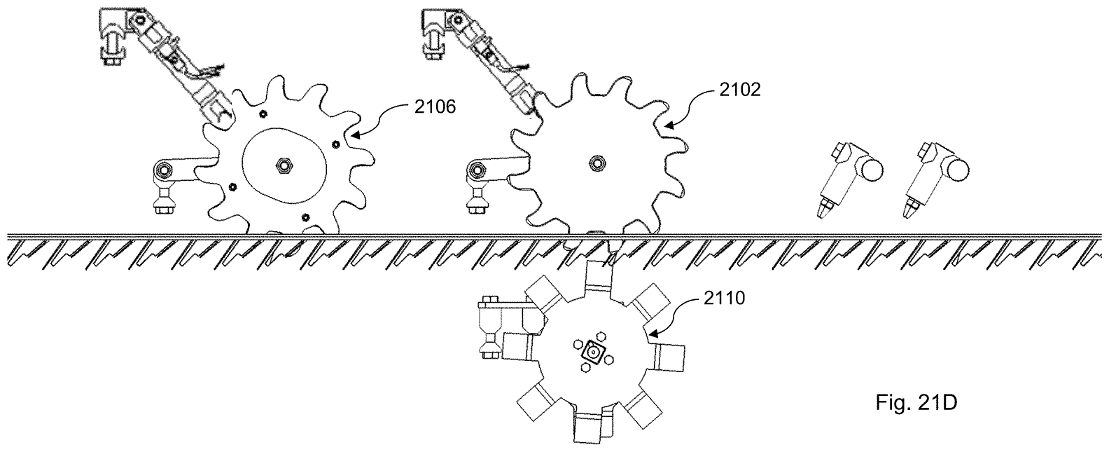

FIGS. 21A-21D are a sequence of side-view drawings illustrating a tower cleaning system 2100, according to embodiments of the disclosure. FIG. 21A1 illustrates an opposite side view of the tower cleaning system 2100. The system includes a plug remover assembly that removes the plugs from towers which have been harvested by a separate machine upstream.

The system includes a first wheel 2102 having teeth 2104, a second wheel 2106 (shown to the left of the first wheel 2102) having teeth 2108, and a “puller” wheel 2110 (shown below the first wheel 2102) having teeth 2112. According to embodiments of the disclosure, the first and second wheels 2102 and 2106 are gear-like in nature. According to embodiments of the disclosure, each first wheel 2102 may comprise a solid hard plastic (e.g., ABS) or PVC material. According to embodiments of the disclosure, each second wheel 2106 may comprise a stack of thin, sheet metal, layered wheels of the same shape with sharp teeth. Note that the labeling of wheels 2102 and 2106 as “first” and “second” wheels, respectively, is arbitrary herein and does not indicate an order of operation.

Different embodiments of the disclosure may employ one or more extendable and retractable linear “pushing” members instead of the first or second wheels 2102 and 2106. For example, first wheel 2102 may be replaced by a linear device similar to plunger 811, which may be actuated in a reciprocating extending and retracting motion to push against the plant material and soil in the plant container 303. Using one or more sensors detecting the tower or the plant containers 303, the controller may synchronize the linear plungers to ensure alignment with the plant containers 303.

As another example, embodiments of the disclosure may employ one or more linear “shredding” members with sharp sheet metal layers or spikes instead of the second wheel 2106 to loosen the soil and plant material. These linear “shredding” members would be actuated and synchronized in a manner similar to that used for the linear pushing members.

A first actuated lever arm 2120 is coupled to the first wheel 2102 and a fixed post 2122, and a second actuated lever arm 2124 is coupled to the second wheel 2106 and a fixed post 2126. The puller wheel 2110 is coupled to a fixed post 2128.

The actuated lever arms 2120 and 2124 may each be actuated by a rotary actuator (not shown) such as a motor to cause the corresponding lever arm to rotate so that the wheel to which it is coupled moves toward a tower 100.

As shown in the opposite side view of FIG. 21A1 for first wheel 2102 as an example, lever arm 2120 includes a hole through which the axle of wheel 2102 can freely rotate. As an alternative to rotary actuation, a linear actuator 2150 extends and retracts to move lever arm 2120 about its pivot point 2121, to thereby move wheel 2102 down and up, respectively, with respect to traveling tower 100, which includes plant containers (e.g., plug holders) 303. (Actuator 2150 is shown in its extended position in the figure.) According to embodiments of the disclosure, a similar arrangement is used for second wheel 2106.

One or more air blowers 2140 are positioned after the first and second wheels 2102 and 2106 and the puller wheel 2110 with respect to the direction of travel 2150 of the tower 100.

In FIG. 21A, the tower 100 is pushed by an actuator, e.g., a motor such as drive motor 907, through the cleaning system 2100.

Referring to FIG. 21B, as the tower 100 moves under second wheel 2106, an actuator rotates the second arm 2124 clockwise so that the teeth 2108 of the second wheel 2106 engage with soil and plant material in plant containers 303 on the stem side of the plant containers 303 (also the stem side of the plant plugs themselves) to thereby loosen the soil and plant material such as plant stems and crowns. Actuation may be triggered in response to a sensor (not shown) sensing the plant containers 303 under the second wheel 2106.

Referring to FIG. 21C, as the tower 100 moves under first wheel 2102, an actuator rotates the first arm 2120 clockwise so that the teeth 2104 of the first wheel 2102 engage with plant material in plant containers 303 on the stem side of the plant containers 303 to push the soil and plant material in the plant containers 303. According to embodiments of the disclosure, the first wheel 2102 may be thicker than the combined thickness of the layers of second wheel 2106.

According to embodiments of the disclosure, the actuators for moving the lever arms to push the first and second wheels 2102 and 2016 toward the tower 100 and against the tower face plate 101 (and against the plant material and soil in plant containers 303) may be pneumatically, hydraulically or electrically driven. According to embodiments of the disclosure, the first and second wheels 2102 and 2016 are not actively rotated, but rather passively rotate as their teeth are moved by the plant containers with which they are engaged as the tower travels through the system 2100. By circumferentially spacing the teeth as a function of the linear spacing of the plant containers in the tower 100, their motion is synchronized with the tower motion.

Referring to FIG. 21C, the teeth 2112 of puller wheel 2110 (which may be fixed but rotatable) engage with plant material on the root side of the plant containers 303 as the tower 100 travels through the system 2100. According to embodiments of the disclosure, the lower, puller wheel 2110 is rotationally actuated pneumatically, hydraulically or electrically and spins at a constant speed. According to embodiments of the disclosure, the puller wheel 2110 is actuated to rotate against the direction of travel of the tower (e.g., counterclockwise when the tower travels to the right). According to embodiments of the disclosure, the puller wheel 2110 has sheet metal teeth that assist in tearing plugs and roots out of the plant containers 303 after the wheels 2102 and 2106 have already pushed the soil plugs much of the way out of the plant containers 303. According to embodiments of the disclosure, the puller wheel 2110 is actuated in response to a sensor (not shown) sensing the approach of a plant container 303 or, alternatively, of the tower 100 itself.

According to embodiments of the disclosure, after the wheels, the system includes air nozzles 2140 that are aimed directly into the plug holders 303. Referring to FIG. 21D, these air nozzles blow constant high-pressure air into the plug holders to remove the remaining plug debris and any potential plugs not removed by the prior processes. As shown, the air nozzles 2140 are aimed at the stem side of the plant containers 303, but the system may also include air jets aimed at the root side.

After the tower 100 has traveled past an upper wheel 2106 or 2102, the corresponding lever arm 2124 or 2120 may be actuated to lift the wheel back up.

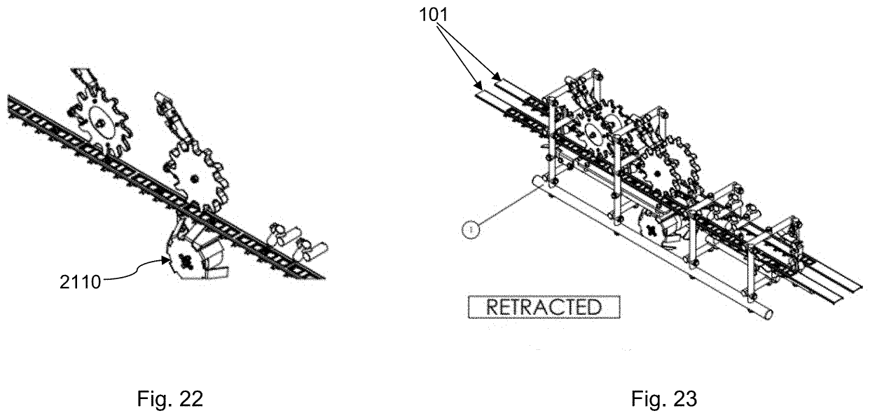

FIG. 22 illustrates a perspective view of a tower cleaning system in a retracted configuration for single-sided tower 100, according to embodiments of the disclosure. The perspective view of puller wheel 2110 shows that its teeth may be angled inward toward its mounting point so that an edge of the teeth will be presented almost horizontally to the plant matter with which it comes in contact.

FIG. 23 illustrates a perspective view of a tower cleaning system in a retracted configuration for a double-sided tower 100, according to embodiments of the disclosure. Two cleaning systems such as system 2100 are used in parallel, one for each set of plant containers 303 in the two front face plates 101 of the tower.

The cleaning system 2100 operates in a different manner from that of previous embodiments. For example, FIG. 19 shows a plunger 811 pushing a plant plug 1901A from the root side of a plant container 303A after brush 1607 has broken up roots on the root side. In contrast, in system 2100, wheels 2102 and 2106 break up soil and plant matter and push on the stem side of the plant containers 303, and wheel 2112 pulls the plant material from the root side.

The inventors have observed that roots from multiple adjacent plant containers 303 often become entangled. As a result, pulling from the root side requires less force than otherwise to remove a soil plug on a per-plug basis, and thus is a more efficient removal technique. Moreover, as described elsewhere herein with reference to FIGS. 20A-20D, the plunger 811 of embodiments of the disclosure is activated in response to detection of a plant container 2005 by a sensor. Alignment of the plunger 811 with the plant container requires a given degree of precision to synchronize the plunger activation with the plant containers. In contrast, use of rotating structures like wheels 2102 and 2106 to push on the plant material in the plant containers avoids the need to sense the plant containers with the same degree of precision, particularly where the circumferential distance between the teeth corresponds to the linear distance between the plant containers on the tower.

Moreover, pushing on the entangled roots on the root side of the plant containers 303 is not nearly as effective as pulling from the root side, especially when the roots are not completely broken up. Pulling from the root side is also a cleaner approach that does not leave as much debris because the pulling approach does not need to break up the roots as much as the approach of pushing from the root side.

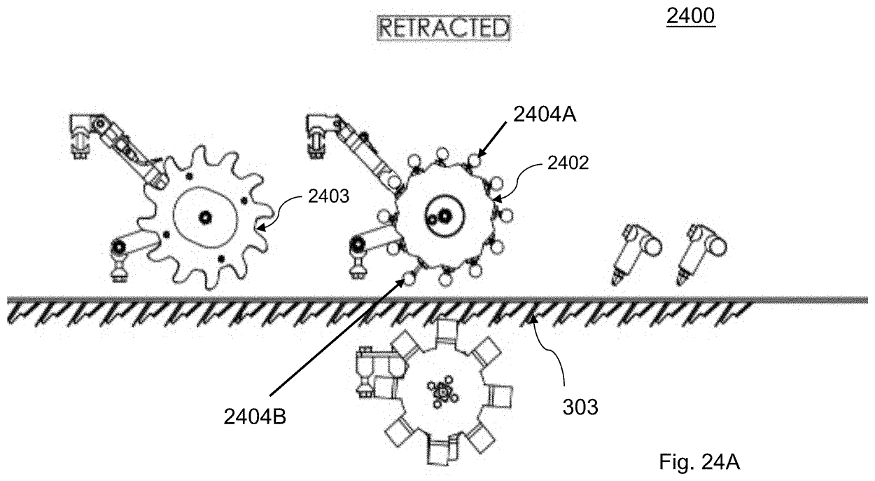

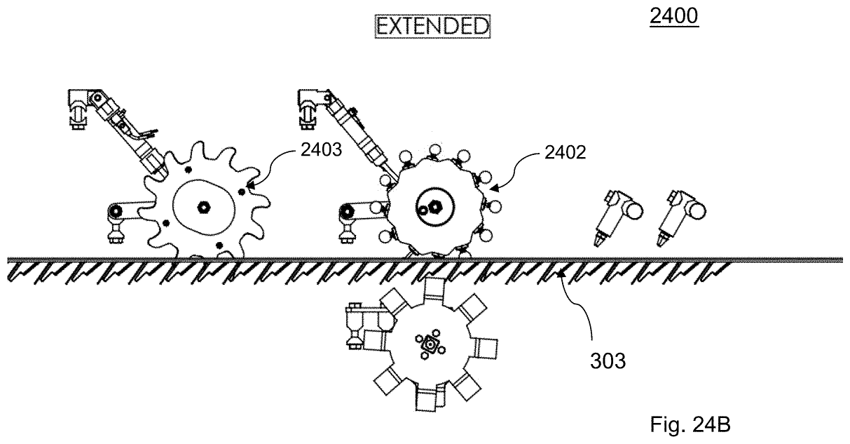

FIGS. 24A-24B are side-view drawings of a tower cleaning system 2400, according to embodiments of the disclosure. First wheel 2402 and second wheel 2403 are both disposed in retracted and extended positions in FIGS. 24A and 24B, respectively. Here, instead of fixed teeth, the first wheel 2402 includes extendable plungers 2404, including plunger 2404A in a retracted position and plunger 2404B in an extended position.

Referring to FIG. 24B, the plunger 2404B and, optionally, adjacent plungers, are in an extended position during engagement with plant containers 303 so as to push against plant material and soil in the plant containers 303.

According to embodiments of the disclosure, the end of the plungers have a spherical shape sized so they can insert into the plug holders 303 and push the plant plugs. An advantage of the spherical shape is that it lacks edges so the plunger does not get caught on anything and is easier to clean. The plungers may comprise food-safe hard material, e.g., UHMW or HDPE if they're non-metallic, or stainless steel if metallic.

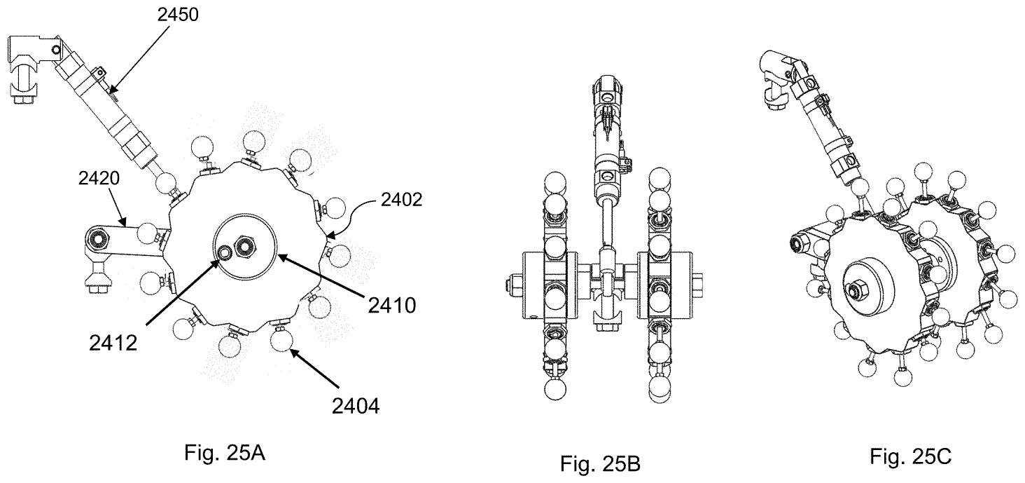

FIGS. 25A, 25B, and 25C show the first wheel 2402, with radial plungers 2404, attached to lever arm 2420 and linear actuator (e.g., pneumatic piston) 2450 in side, end, and isometric views, respectively, for cleaning a double-sided tower, according to embodiments of the disclosure. The wheel 2404 is rotatable about an inner bearing 2410 having an air inlet 2412. A hose (not shown) from an air supply (not shown) may be connected to the air inlet 2412 to supply air to the air inlet 2412.

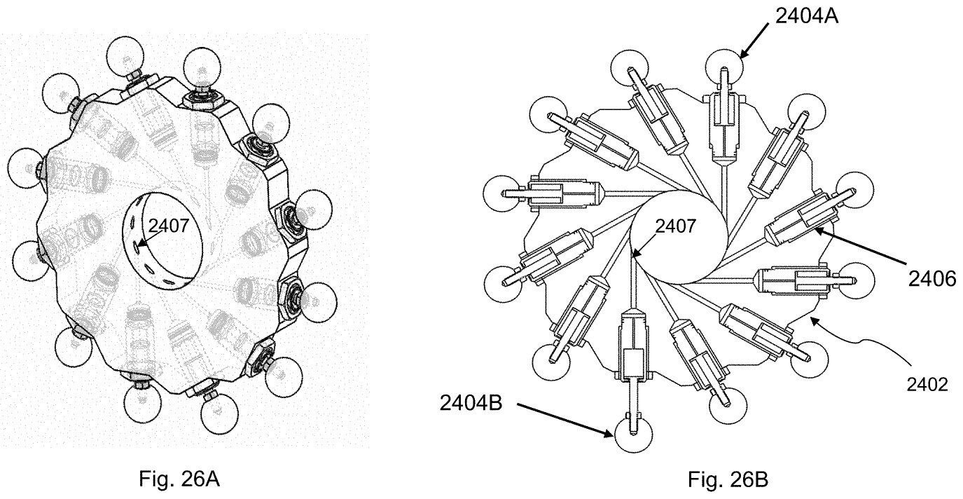

FIGS. 26A and 26B show, respectively, a transparent isometric view and a cross-sectional view of the first wheel 2402 with linear actuators 2406 and air holes 2407. As shown, the linear actuators 2406 are pneumatically powered.

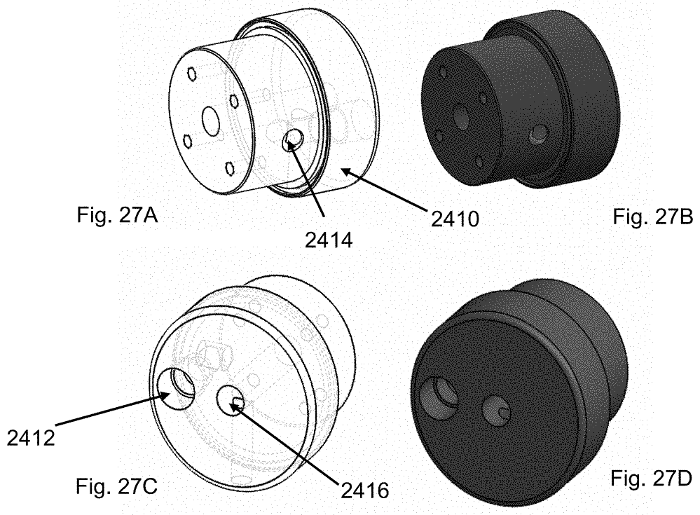

FIGS. 27A and 27B show rear isometric transparent and solid views, respectively, of the inner bearing 2410. FIGS. 27C and 27D show front isometric transparent and solid views, respectively, of the inner bearing 2410. The inner bearing 2410 includes the air inlet 2412, an air outlet 2414, and a mounting hole 2416.

Referring to FIG. 24B, as the tower 303 advances, the first wheel 2402 rotates counterclockwise about the inner bearing 2410. The inner bearing 2410 is stationary as it is held in place by, e.g., the lever arm 2420. As the first wheel 2402 rotates, an air hole 2407 of first wheel 2402 will align with the stationary air outlet 2414 of the inner bearing 2410, enabling air to enter the linear actuator 2406 corresponding to the aligned air hole 2407. The resulting pressure will cause the plunger 2404 of the linear actuator 2406 to extend and thereby push and soil and plant material in the holder 303 with which it is engaged.

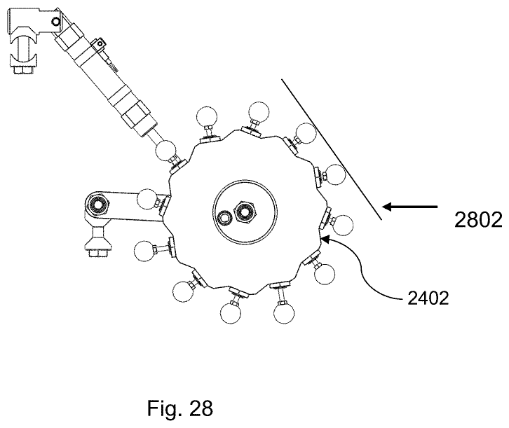

As the first wheel 2402 continues to rotate, it will disengage from plant container 303. It may be desirable to have the extended plunger 2404 retract. Retraction could be enabled with a spring in the actuator piston along with an air exhaust valve in the inner bearing 2410. Alternatively, as shown in FIG. 28, the system may include a fixed stationary surface 2802 that pushes the plungers 2404 back in place as they pass the surface 2802 during rotation of the wheel 2402.

In other embodiments, the linear actuators may be powered by other means. For example, the actuators may be electric solenoids. Each plunger may correspond to a switch in a similar position as the inner air holes 2407, and the inner bearing may include a conductive strip in place of the air outlet 2414. As the first wheel rotates, the switch closes as it contacts the stationary conductive strip to thereby power the solenoid and extend the corresponding plunger.

Systems and methods have been described in general terms as an aid to understanding details of embodiments of the disclosure. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the invention.

All references cited herein, including, without limitation, articles, publications, patents, patent publications, and patent applications, are incorporated by reference in their entireties for all purposes, except that any portion of any such reference is not incorporated by reference herein to the extent it: (1) is inconsistent with embodiments of the disclosure expressly described herein; (2) limits the scope of any embodiments described herein; or (3) limits the scope of any terms of any claims recited herein. Mention of any reference, article, publication, patent, patent publication, or patent application cited herein is not, and should not be taken as an acknowledgment or any form of suggestion that it constitutes valid prior art or forms part of the common general knowledge in any country in the world, or that it discloses essential matter.

In the claims below, a claim n reciting “any one of the preceding claims starting with claim x,” shall refer to any one of the claims starting with claim x and ending with the immediately preceding claim (claim n-1). For example, claim 35 reciting “The system of any one of the preceding claims starting with claim 28” refers to the system of any one of claims 28-34.

### Selected Embodiments of the Disclosure

1. A hydroponic tower cleaning system configured to clean a multi-piece hydroponic tower, said multi-piece hydroponic tower comprising (i) a tower body, said tower body defining at least a first tower cavity, wherein a first edge portion of said tower body includes a first tower body hinge member, (ii) a first tower face plate, wherein an edge portion of said first tower face plate includes a first face plate hinge member, wherein said first tower face plate is hingeably coupled to said tower body via said first tower body hinge member and said first face plate hinge member, wherein said first tower face plate is positionable relative to said tower body in at least a first tower cavity closed position and a first tower cavity open position, said first tower face plate comprising a first plurality of plant container cut-outs, (iii) a first fastener configured to temporarily latch said first tower face plate to said tower body when said first tower face plate is in said first tower cavity closed position, and (iv) a first plurality of plant containers attached to said first tower face plate via said first plurality of plant container cut-outs, said hydroponic tower cleaning system comprising:
a drive system configured to propel said multi-piece hydroponic tower through said hydroponic tower cleaning system;
an alignment system configured to align said multi-piece hydroponic tower body within said hydroponic tower cleaning system;
a brush unit configured to brush said multi-piece hydroponic tower as said multi-piece hydroponic tower is propelled through said hydroponic tower cleaning system; and
a plunger unit configured to expel growth media and plant debris from said first plurality of plant containers as said multi-piece hydroponic tower is propelled through said hydroponic tower cleaning system.

2. The hydroponic tower cleaning system of embodiment 1, further comprising an air blower, said air blower configured to direct a jet of air towards said multi-piece hydroponic tower after said multi-piece hydroponic tower has passed said brush unit and said plunger unit and as said multi-piece hydroponic tower is propelled through said hydroponic tower cleaning system.

3. The hydroponic tower cleaning system of embodiment 1, wherein said brush unit is comprised of a first rotating brush configured to brush a plurality of plant container surfaces of each of said first plurality of plant containers, said plurality of plant container surfaces adjacent to an inside surface of said first tower face.

4. The hydroponic tower cleaning system of embodiment 3, wherein said brush unit is further comprised of a second rotating brush configured to brush an outside surface of said first tower face.

5. The hydroponic tower cleaning system of embodiment 1, said plunger unit further comprising a plunger, wherein said plunger is configured to controllably alternate between a withdrawn position and an extended position, wherein said plunger in said withdrawn position allows passage of said multi-piece hydroponic tower and said first plurality of plant containers, and wherein said plunger in said extended position extends at least partially into each plant container of said first plurality of plant containers as said multi-piece hydroponic tower is propelled through said hydroponic tower cleaning system.

6. The hydroponic tower cleaning system of embodiment 5, said plunger unit further comprising a plant container position sensor, said plant container position sensor configured to monitor a position of each of said first plurality of plant containers relative to said plunger unit and to activate said plunger unit as each plant container of said first plurality of plant containers is aligned with said plunger unit, wherein said plunger unit extends said plunger when activated.

7. The hydroponic tower cleaning system of embodiment 5, wherein said plunger of said plunger unit is pneumatically driven.

8. The hydroponic tower cleaning system of embodiment 1, further comprising a plurality of idler rollers, said plurality of idler rollers comprised of at least one upper idler roller configured to limit upward motion of said first tower face plate as said multi-piece hydroponic tower is propelled through said hydroponic tower cleaning system, said plurality of idler rollers further comprised of at least one lower idler roller configured to limit downward motion of said first tower face plate as said multi-piece hydroponic tower is propelled through said hydroponic tower cleaning system.

9. The hydroponic tower cleaning system of embodiment 8, said at least one upper idler roller comprised of a first upper idler roller located before said brush unit, a second upper idler roller located after said brush unit and before said plunger unit, and a third upper idler roller located after said plunger unit; and said at least one lower idler roller comprised of a first lower idler roller located before said brush unit, a second lower idler roller located after said brush unit and before said plunger unit, and a third lower idler roller located after said plunger unit.

10. The hydroponic tower cleaning system of embodiment 1, further comprising at least one set of tower body alignment rollers, said at least one set of tower body alignment rollers comprising a first tower body alignment roller and a second tower body alignment roller, said first tower body alignment roller located on a first side of said tower body and configured to locate and align said first side of said tower body, and said second tower body alignment roller located on a second side of said tower body and configured to locate and align said second side of said tower.

11. The hydroponic tower cleaning system of embodiment 1, said drive system further comprising at least one drive roller coupled to a drive motor and configured to contact said tower body along at least a first tower body side, wherein operation of said drive motor forces rotation of said at least one drive roller, wherein rotation of said at least one drive roller propels said multi-piece hydroponic tower through said hydroponic tower cleaning system.

12. The hydroponic tower cleaning system of embodiment 11, said drive system further comprising at least one secondary drive roller configured to contact said tower body along at least a second tower body side, wherein said at least one secondary drive roller is not coupled to said drive motor.

13. The hydroponic tower cleaning system of embodiment 1, said multi-piece hydroponic tower further comprising:
a first modified V-shaped groove running along the length of a first side of said tower body, said first modified V-shaped groove comprising a first inner groove wall, a first sloped groove wall coupling a first edge of said first inner groove wall to a first edge of said first side of said tower body, and a second sloped groove wall coupling a second edge of said first inner groove wall to a second edge of said first side of said tower body; and
a second modified V-shaped groove running along the length of a second side of said tower body, said second modified V-shaped groove comprising a second inner groove wall, a third sloped groove wall coupling a first edge of said second inner groove wall to a first edge of said second side of said tower body, and a fourth sloped groove wall coupling a second edge of said second inner groove wall to a second edge of said second side of said tower body.

14. The hydroponic tower cleaning system of embodiment 13, said first inner groove wall substantially parallel to said first side of said tower body and substantially perpendicular to a first tower cavity rear wall, and said second inner groove wall substantially parallel to said second side of said tower body and substantially perpendicular to said first tower cavity rear wall.

15. The hydroponic tower cleaning system of embodiment 13, said drive system further comprising a plurality of drive rollers, said plurality of drive rollers comprising at least a first drive roller and at least a second drive roller, wherein said first drive roller is coupled to a drive motor and configured to contact said tower body within said first modified V-shaped groove, wherein operation of said drive motor forces rotation of said first drive roller, wherein rotation of said first drive roller propels said multi-piece hydroponic tower through said hydroponic tower cleaning system, wherein said second drive roller is not coupled to said drive motor, wherein said second drive roller is configured to contact said tower body within said second modified V-shaped groove.

16. The hydroponic tower cleaning system of embodiment 15, wherein said second drive roller is mounted via a pneumatic coupler and configured to apply pressure to said tower body via said second inner groove wall of said second modified V-shaped groove.

17. The hydroponic tower cleaning system of embodiment 15, wherein said second drive roller is mounted via a spring coupler and configured to apply pressure to said tower body via said second inner groove wall of said second modified V-shaped groove.

18. The hydroponic tower cleaning system of embodiment 13, wherein said multi-piece hydroponic tower is a dual-sided hydroponic tower, wherein said tower body defines said first tower cavity and a second tower cavity, wherein said first body hinge member of said first edge portion of said tower body corresponds to said first tower cavity, said tower body further comprising a second body hinge member corresponding to a second edge portion of said tower body, said second tower body hinge member of said second edge portion of said tower body corresponding to said second tower cavity, said multi-piece hydroponic tower further comprising:
a second tower face plate, wherein an edge portion of said second tower face plate includes a second face plate hinge member, wherein said second tower face plate is hingeably coupled to said tower body via said second tower body hinge member and said second face plate hinge member, wherein said second tower face plate is positionable relative to said tower body in at least a second tower cavity closed position and a second tower cavity open position, said second tower face plate comprising a second plurality of plant container cut-outs;
a second fastener configured to temporarily latch said second tower face plate to said tower body when said second tower face plate is in said second tower cavity closed position; a second plurality of plant containers attached to said second tower face plate via said second plurality of plant container cut-outs; and
wherein said brush unit is comprised of a first rotating brush configured to brush a first plurality of plant container surfaces of each of said first plurality of plant containers, said first plurality of plant container surfaces adjacent to an inside surface of said first tower face, and wherein said brush unit is comprised of a second rotating brush configured to brush a second plurality of plant container surfaces of each of said second plurality of plant containers, said second plurality of plant container surfaces adjacent to an inside surface of second tower face; and
wherein said plunger unit is configured to expel growth media and plant debris from said first plurality of plant containers and said second plurality of plant containers as said multi-piece hydroponic tower is propelled through said hydroponic tower cleaning system.

19. The hydroponic tower cleaning system of embodiment 18, said first modified V-shaped groove centered between said first tower cavity and said second tower cavity, and said second modified V-shaped groove centered between said first tower cavity and said second tower cavity.

20. The hydroponic tower cleaning system of embodiment 19, said first inner groove wall substantially parallel to said first side of said tower body and substantially perpendicular to a first tower cavity rear wall, and said second inner groove wall substantially parallel to said second side of said tower body and substantially perpendicular to a second tower cavity rear wall.

What is claimed is:

1. A plant support tower cleaning system configured to clean a plant support tower, the tower cleaning system comprising:
a drive actuator configured to propel the tower through the tower cleaning system;
one or more linear or rotating first structures, each having at least one projection;
one or more first actuators coupled to the one or more first structures to push the at least one projection of the one or more first structures against a stem side of plant material in a plurality of plant containers in the tower as the tower is propelled through the tower cleaning system;
a rotating second structure having at least one circumferential projection to pull plant material from a root side of the plurality of plant containers as the tower is propelled through the tower cleaning system; and
a second actuator to rotate the second structure.

2. The system of claim 1, wherein each of the one or more first structures comprises a wheel and the at least one projection comprises a plurality of circumferential projections.

3. The system of claim 1, wherein the one or more first structures comprise one or more linear structures and the least one projection is extendable and retractable.

4. The system of claim 1, wherein the one or more first structures are not actuated in any rotational direction.

5. The system of claim 1, further comprising:
a linear or rotating third structure having at least one projection, wherein the third structure is not actuated in any rotational direction; and
a third actuator coupled to the third structure to push the at least one projection of the third structure against the stem side of plant material to loosen plant material in the plurality of plant containers as the tower is propelled through the tower cleaning system.

6. The system of claim 5, wherein the third structure comprises a wheel and the at least one projection is a plurality of circumferential projections.

7. The system of claim 5, wherein the third structure is a linear structure and the least one projection of the third structure is extendable and retractable.

8. The system of claim 5, wherein the third structure is closer than the first structure to a leading edge of the tower as the tower initially approaches the system as the tower is propelled through the system, the system further comprising a controller configured to actuate the third actuator before actuating the one or more first actuators.

9. The system of claim 1, wherein the rotating second structure is not actuated in any translational direction toward the tower as the tower travels through the cleaning system.

10. The system of claim 1, wherein the rotating second structure comprises a wheel and the at least one projection comprises a plurality of circumferential projections

11. The system of claim 1, further comprising an air blower, wherein the controller is configured to cause the air blower to direct a jet of air towards the tower after a leading edge of the tower has passed at least one of the one or more first structures as the tower is propelled through the tower cleaning system.

12. The system of claim 1, further comprising a position sensor configured to detect the tower, wherein a controller is configured to actuate the first actuator in response to the sensor detecting the tower.

13. The system of claim 1, further comprising at least one idler element to limit upward motion of the plurality of plant containers as the tower is propelled through the tower cleaning system.

14. The system of claim 1, further comprising at least one tower alignment element configured to contact a first side of the tower and maintain alignment of the tower.

15. The system of claim 1, wherein the plant support tower comprises (i) a tower body, the tower body defining at least a first tower cavity, (ii) a first tower face plate, wherein the first tower face plate is coupled to the tower body, and the first tower face plate is positionable relative to the tower body in at least a first tower cavity closed position and a first tower cavity unclosed position, and (iii) the first tower face plate includes the plurality of plant containers.

16. The system of claim 2, wherein the wheel includes a plurality of fourth actuators, each fourth actuator for extending a corresponding circumferential projection of the plurality of circumferential projections to which it is coupled.

17. The system of claim 16, wherein each fourth actuator is disposed radially and extends its corresponding circumferential projection to push the corresponding circumferential projection against a stem side of plant material.
